(19) United States
(12) Patent Application Publication
(10) Pub. No.: US 2026/0320754 A1
(43) Pub. Date: Oct. 15, 2026

(54) HIGH SPEED REAL-TIME GLOBAL ENCODING METHOD ENABLING CONSISTENT IMAGE QUALITY WITH SPECIFIED SIZE WHILE GENERATING VIDEO WITH INFORMATION DISTRIBUTION SIMILAR TO SOURCE VIDEO

(71) Applicant: AINATION CO., LTD., Seocho-gu, Seoul (KR)

(72) Inventors: Ji Hoon KWAK, Seocho-gu, Seoul (KR); Ho Jin CHOI, Seocho-gu, Seoul (KR)

(21) Appl. No.: 19/484,023

(22) PCT Filed: Apr. 10, 2025
(86) PCT No.: PCT/KR2025/004863

§ 371 Date: Nov. 13, 2025

(30) Foreign Application Priority Data
Apr. 11, 2024 (KR) 10-2024-0048820

(51) Int. Cl. G06T 5/60; G06V 20/40

(52) U.S. Cl. CPC G06T 5/60; G06V 20/46; G06T 2207/20084

(57) ABSTRACT

An encoding method which efficiently distributes resources is disclosed in the present disclosure. According to the video encoding method of the present disclosure, a part of the video is divided into block data and the divided data is input to the image processing model so that the video encoding method may be executed while storing the data in the main memory of the computing device. By doing this, the image processing and encoding can be performed at a faster speed than the related art.

### TECHNICAL FIELD

The present disclosure relates to video encoding, and more particularly, to an encoding method enabling efficient resource distribution.

### BACKGROUND ART

This application claims the priority of Korean Patent Application No. 10-2024-0048820 filed on Apr. 11, 2024, in the Korean Intellectual Property Office, the disclosure of which is incorporated herein by reference.

The contents described in this part merely provide background information on the exemplary embodiment of the present disclosure, but do not constitute the related art.

The basic principle of a video is based on a kind of optical illusion, in which a series of still images is sequentially displayed at a high speed, so that images are perceived as continuous motion. If still images are sequentially displayed, the human brain cannot clearly recognize the still images due to the afterimage effect, and instead, perceives the still images as being connected to the previous image. Accordingly, the human brain perceives the series of still images as continuous motion.

For a video to appear with natural motion, the still image should be displayed at a rate of 24 frames or more per second. However, instead of storing the entire frame images as-is, video files typically employ a compression method to reduce a large amount of data into a smaller storage size. This process is referred to as video encoding.

Primary bitrate allocation during the video encoding is as follows. Constant bitrate (CBR) is a method for constantly maintaining bitrates. CBR is easy to predict a size of encoded video, and therefore mainly used for real-time streaming or broadcasting. However, the image quality consistency may be degraded. Variable bitrate (VBR) dynamically adjusts bitrates according to the complexity of video. VBR provides better image quality, but it is difficult to predict a file size and has a longer encoding time. Average bitrate (ABR) is an intermediate form in between CBR and VBR, setting an average bitrate target and adjusting bitrates for various parts of the video within a predetermined range. ABR may maintain a predetermined level of image quality while providing a predictable file size better than VBR. Constant rate factor (CRF) is one of VBR and adjusts a bitrate to maintain a specific quality level. The lower the CRF, the better the image quality and the larger the file size. CRF is used when a file storage space is not constrained.

### DISCLOSURE

### Technical Problem

An object of the present disclosure is to provide an encoding method enabling efficient resource distribution.

Objects of the present disclosure are not limited to the above-mentioned objects, and other objects, which are not mentioned above, can be clearly understood by those skilled in the art from the following descriptions.

### Technical Solution

In order to achieve the above-described object, according to an aspect of the present disclosure, a video encoding method includes (a) a step of storing video data as input data by a processor; (b) a step of extracting block data with a predetermined size from the video data by the processor; (c) a step of inputting the block data to an image processing model by the processor; and (d) a step of calculating a characteristic value of image data output from the image processing model and encoding the image data based on the calculated characteristic value, by the processor. At this time, the steps (b) and (d) may be repeated until the block data is extracted from the entire video data.

According to the exemplary embodiment of the present disclosure, the step (d) may be a step of encoding the image data in a bit resource which is allocated in advance to the block data, by the processor.

In order to achieve the above-described object, according to another aspect of the present disclosure, a video encoding method includes (a) a step of storing video data as input data by a processor; (b) a step of calculating a characteristic value for the entire video data by the processor; (c) a step of extracting block data with a predetermined size from the video data by the processor; (d) a step of inputting the block data to an image processing model by the processor; and (e) a step of encoding the image data output from the image processing model based on the characteristic value calculated in the step (b), by the processor. At this time, the steps (c) and (e) may be repeated until the block data is extracted from the entire video data.

According to another exemplary embodiment of the present disclosure, the step (e) may be a step of encoding the image data in a bit resource which is allocated in advance to the entire input video, by the processor.

According to the present disclosure, the characteristic value may be a complexity of a (static or dynamic) image. In this case, the processor may calculate the complexity by at least any one of motion estimation, variability, a prediction error, quality constraints, macroblock partitioning, and cutaway.

According to the present disclosure, the processor may generate the block data as at least one or more frame data and input the generated frame data to the image processing model. At this time, the image processing model may be a denoising or super resolution model.

According to the present disclosure, the processor may encode the data by adjusting the bitrate according to the calculated characteristic value.

According to the present disclosure, the processor may integrate the encoded data to output as one video data.

According to the present disclosure, the processor may encode the image data output from the image processing model once to output as one video data.

The video encoding method according to the present disclosure may be executed while storing the block data in the main memory of the computing device.

The video encoding method according to the present disclosure may be implemented as a computer program which is created to perform each step in the computer to be recorded in a computer readable recording medium.

Other detailed matters of the embodiments are included in the detailed description and the drawings.

### Advantageous Effects

According to an aspect of the present disclosure, when the video is encoded, a bitrate resource may be efficiently distributed. Accordingly, a quality of a screen may be increased even in a limited resource.

According to another aspect of the present disclosure, the processing in the main memory enables fast encoding.

According to still another aspect of the present disclosure, the encoding for the entire image may be completed concurrently with the completion of final frame processing of image data which is sequentially input to an image processing model. Accordingly, there is no need to wait for an additional encoding process for entire processed image data, so that real-time encoding is possible.

The effects of the present disclosure are not limited to the technical effects mentioned above, and other effects which are not mentioned can be clearly understood by those skilled in the art from the following description

### DESCRIPTION OF DRAWINGS

FIG. 1 is a reference diagram for an image processing and encoding process by means of an image processing model of the related art.

FIG. 2 is a flowchart of a video encoding method according to an exemplary embodiment of the present disclosure.

FIG. 3 is a reference diagram for block-based two-pass encoding according to an exemplary embodiment of the present disclosure.

FIG. 4 is a flowchart of a video encoding method according to another exemplary embodiment of the present disclosure.

FIG. 5 is a reference diagram for separable two-pass encoding according to another exemplary embodiment of the present disclosure.

### BEST MODE

Advantages and characteristics of the present disclosure disclosed in the present specification, and a method of achieving the advantages and characteristics will be clear by referring to exemplary embodiments described below in detail together with the accompanying drawings. However, the present specification is not limited to exemplary embodiments disclosed herein but will be implemented in various different forms. The exemplary embodiments are provided by way of example only so that a person of ordinary skill in the art can fully understand the disclosures of the present specification and the scope of the present specification. Therefore, the present specification will be defined only by the scope of the appended claims.

The terms used in the present disclosure are for explaining the embodiments rather than limiting the scope of the present disclosure. Unless particularly stated otherwise in the present specification, a singular form also includes a plural form. The term “comprise” and/or “comprising” used in the specification does not exclude the presence or addition of one or more other components in addition to the mentioned component.

Like reference numerals generally denote like elements throughout the specification and “and/or” includes each of mentioned components and all combinations of one or more components. Although the terms “first”, “second”, and the like are used for describing various components, these components are not confined by these terms. These terms are merely used for distinguishing one component from the other components. Therefore, a first component to be mentioned below may be a second component in a technical spirit of the present disclosure.

Unless otherwise defined, all terms (including technical and scientific terms) used in the present specification may be used as the meaning which may be commonly understood by a person with ordinary skill in the art, to which the present disclosure belongs. It will be further understood that terms defined in commonly used dictionaries should not be interpreted in an idealized or excessive sense unless expressly and specifically defined. Hereinafter, exemplary embodiments of the present disclosure will be described in detail with reference to the accompanying drawings.

Encoding includes single-pass encoding and two-pass encoding. According to single-pass encoding, a video file is encoded by a single process. During this process, an encoder processes a file while dynamically adjusting a bitrate. An advantage of the single-pass encoding is a high encoding speed. Accordingly, the single-pass encoding is used for real-time streaming or a situation which requires fast encoding. The disadvantage of the single-pass encoding is that an image quality consistency is low due to a low efficiency of bitrate distribution. Specifically, during the one-pass encoding, there is a high possibility of degradation of an image quality in a complex scene of the video. According to two-pass encoding, a video file is encoded by two processes. During a first pass, the complexity of video data is analyzed. At this time, the complexity of the video and the distribution of the bitrate are analyzed. The encoder calculates a visual complexity of each frame and necessary data amount while passing through the entire video. During a second pass, an optimized bitrate distribution is performed based on this information. An advantage of the two-pass encoding is that the bitrate is more precisely adjusted as compared with the single-pass encoding, thereby improving an overall image quality. Specifically, two-pass encoding may provide a higher bitrate and a better image quality for complex or dynamic scenes. A disadvantage is that the encoding time is longer than that of the single-pass encoding and more system resources are requested for the entire process.

In the meantime, in recent years, a denoising or super resolution task is used for the image processing model. The image processing model is an artificial neural network model and removes a noise of an input image or increases a resolution, to output an image. The problem is that encoded image data is not directly input to the image processing model, but is divided into frame units of images to input frame images.

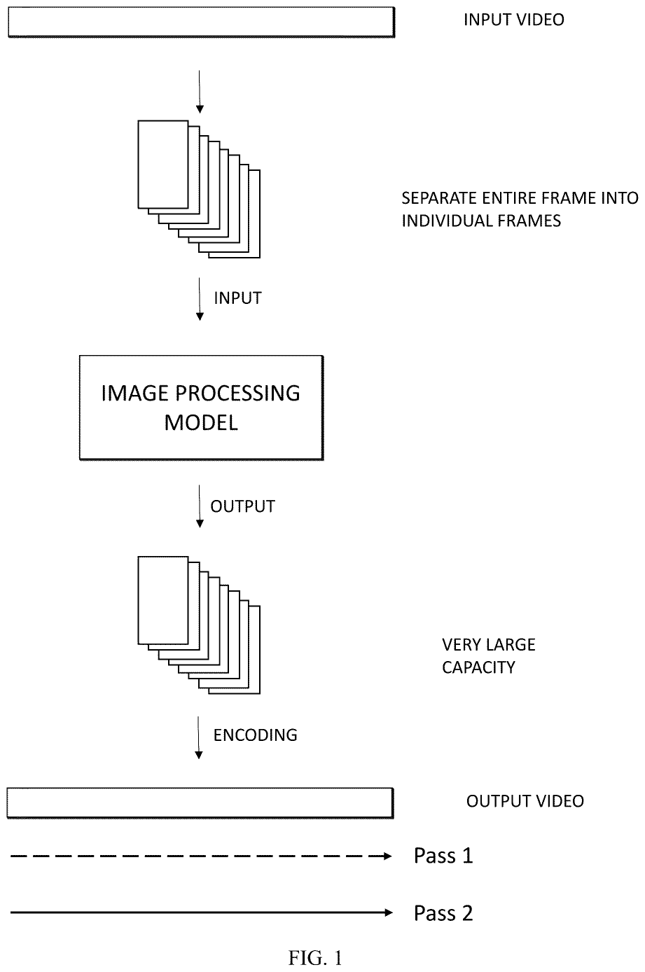

FIG. 1 is a reference diagram for an image processing and encoding process by means of an image processing model of the related art.

Referring to FIG. 1, according to the related art, the entire input video is divided into a plurality of frames. The plurality of separated frames is input to the image processing model and all the processed frame images are collected and encoded to generate an output video. During this process, if the length of the input video is long, the entire frame data which is divided into separate frames is so large that the data is stored and processed not in a main memory, but in a secondary storage, which significantly lowers the processing speed. According to the present disclosure, the main memory refers to a storage device which is directly connected to the processor, such as random access memory (RAM), and the secondary storage refers to a non-volatile storage device, such as hard disk drive (HDD) or solid-state drive (SDD).

General two-pass encoding which is employed when the entire video is accessible is illustrated. In a first pass step (Pass 1), a complexity of the video is analyzed. In a second pass step (Pass 2), a bit is distributed to perform encoding based on the record in the first pass. It is advantageous in that a limited bit resource is most appropriately distributed to perform encoding, but there is a disadvantage in that it takes too much time.

In order to overcome the disadvantage of the related art as described above, the video encoding method according to the present disclosure has been conceived.

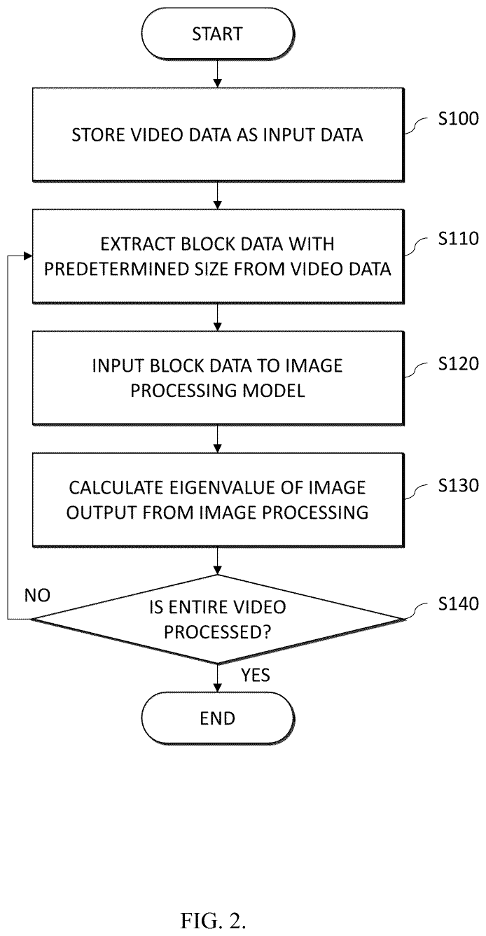

FIG. 2 is a flowchart of a video encoding method according to an exemplary embodiment of the present disclosure.

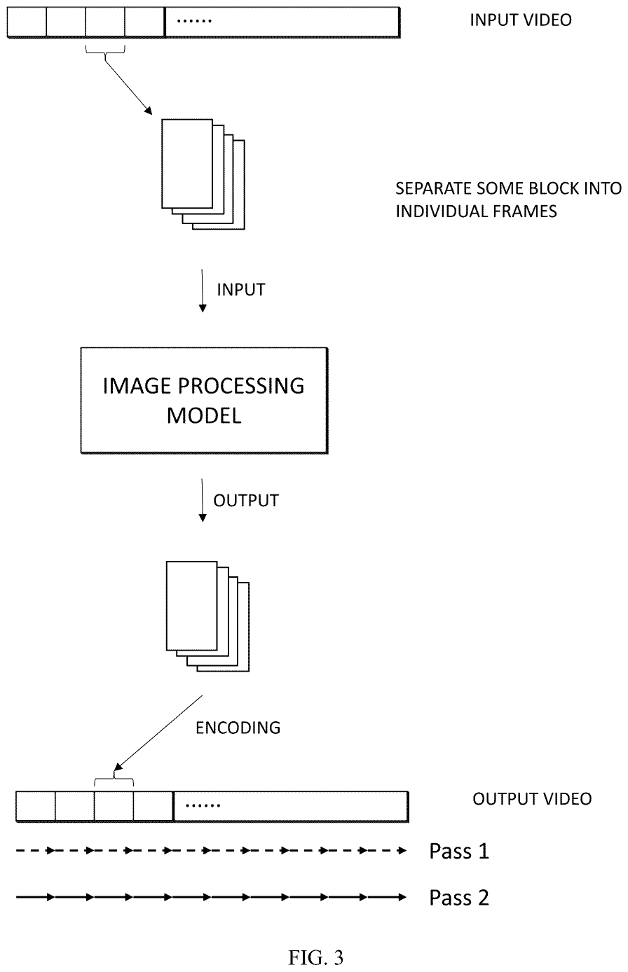

FIG. 3 is a reference diagram for block-based two-pass encoding according to an exemplary embodiment of the present disclosure.

Referring to FIGS. 2 and 3, according to the video encoding method according to the exemplary embodiment of the present disclosure, first, in a step S100, a processor may store video data as input data. The video data is an input video and is not limited by a size and a format of the data.

Next, in a step S110, the processor may extract block data with a predetermined size from the video data. The blocks with various sizes may be provided and desirably, may be sequentially extracted in the video data.

Next, in a step S120, the processor may input the corresponding block data to the image processing model. To be more specific, the processor may generate the block data as at least one or more frame data and input the generated frame data to the image processing model. At this time, a size of the generated frame data is enough for it to be processed in its stored state in a main memory of a computing device. That is, unlike the related art in which the frame data is stored in the secondary storage to be processed due to the large size of the frame data of the entire video, some frame data of the video has a relatively small size enough to be stored and processed in the main memory. To this end, it is obvious that those skilled in the art may appropriately set the size of the block data. In the meantime, the image processing model may be various image processing models, such as denoising or super resolution model.

Next, in a step S130, the processor may calculate a characteristic value of the output image data. The characteristic value is reference data which improves an encoding efficiency during a subsequent encoding process and according to the exemplary embodiment, the characteristic value is a complexity of a (static or dynamic) image.

The processor may calculate the complexity by at least any one of motion estimation, variability, a prediction error, quality constraints, macroblock partitioning, and cutaway. The above-mentioned methods are known to those skilled in the art so that a detailed description thereof will be omitted and may include various methods which can be easily used by those skilled in the art after this application, in addition to the above-mentioned complexity calculating method.

The processor may perform the encoding according to the calculated characteristic value (complexity). For example, a bitrate is adjusted according to the characteristic value (complexity) by increasing a bitrate of a frame having a relatively high complexity and decreasing a bitrate of a frame having a relatively low complexity to perform the encoding. During this process, the processor may perform the encoding within a bit resource which is allocated to the corresponding block data in advance. At this time, the size of the frame data output from the image processing model is also enough to be stored and processed in the main memory. Accordingly, the encoding process of the step S130 may be executed while storing the frame data in the main memory of the computing device.

Next, in a step S140, the processor may determine whether the block data is extracted from the entire video. If the block data is not extracted from the entire video (“NO” in step S140), the process may proceed to the step S110. The steps S110 to S140 may be repeated. In contrast, if the block data is extracted from the entire video (“YES” in the step S140), the encoding process is completed.

Next, the processor may integrate the encoded data to output as one video data.

In the video encoding method according to the exemplary embodiment of the present disclosure, the characteristic is analyzed and encoded only with frames included in the block data so that the encoding method will be referred to as “block-based two-pass encoding”. According to the block-based two-pass encoding according to the present disclosure, as compared with the related art, the data can be stored and processed in the main memory by adjusting the block size, without the secondary storage device, so that a fast processing speed may be achieved. Further, a limited bit resource is most appropriately distributed in one block to be encoded. However, the bit resource is distributed only in one block so that even though any one block of the entire video is simple, extra bit resources are not distributed in the other block.

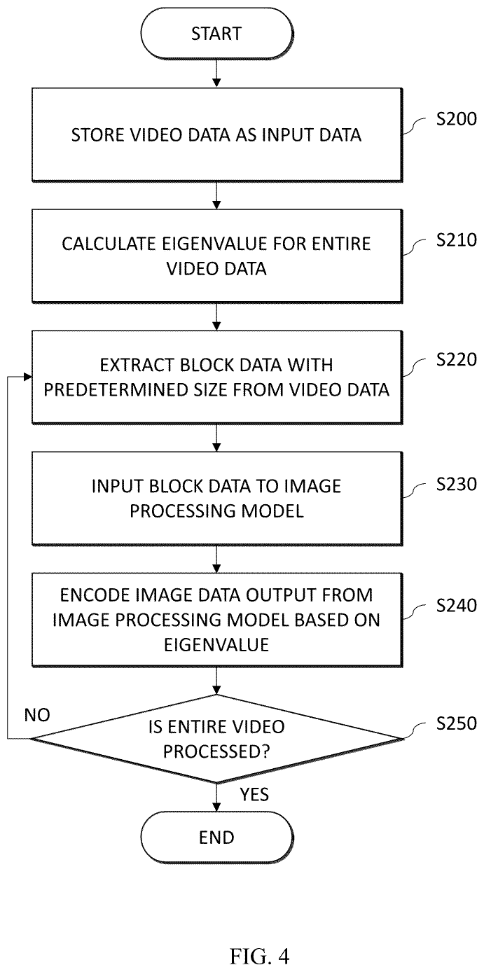

FIG. 4 is a flowchart of a video encoding method according to another exemplary embodiment of the present disclosure.

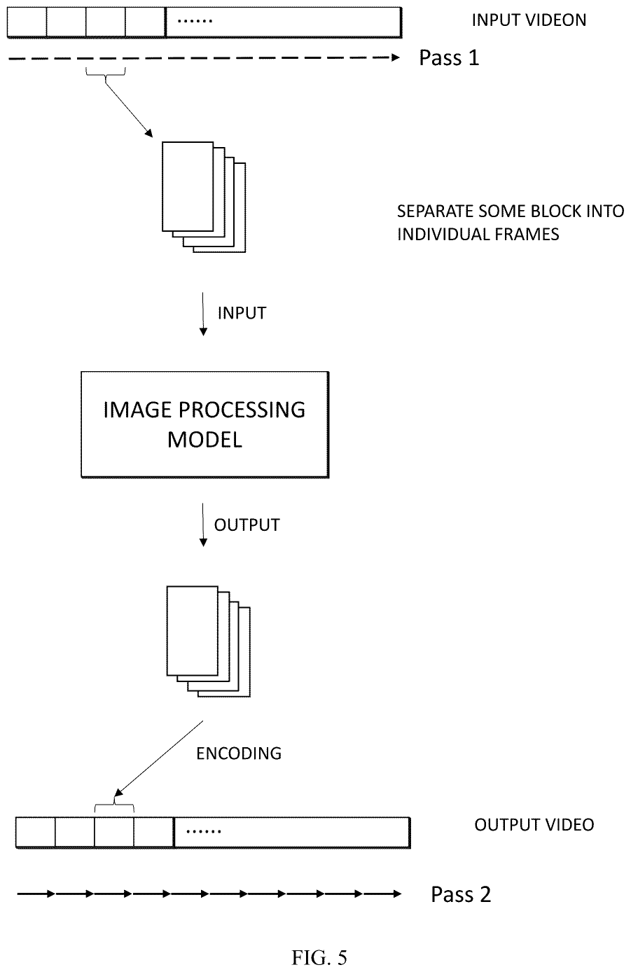

FIG. 5 is a reference diagram for separable two-pass encoding according to another exemplary embodiment of the present disclosure.

Referring to FIGS. 4 and 5, according to the video encoding method according to another exemplary embodiment of the present disclosure, first, in a step S200, a processor may store video data as input data. The video data is an input video and is not limited by a size and a format of the data.

Next, in a step S210, the processor may calculate a characteristic value of entire video data. This part is different from the above-described block-based two-pass encoding. The characteristic value may be a complexity of the image. The processor may calculate the complexity by at least any one of motion estimation, variability, a prediction error, quality constraints, macroblock partitioning, and cutaway. The above-mentioned methods are known to those skilled in the art so that a detailed description thereof will be omitted and may include various methods which can be easily used by those skilled in the art after this application, in addition to the above-mentioned complexity calculating method.

Next, in a step S220, the processor may extract block data with a predetermined size from the video data. There may be various sizes of blocks and desirably, the block data may be sequentially extracted in the video data.

Next, in a step S230, the processor may input the corresponding block data to the image processing model. To be more specific, the processor may generate the block data as at least one or more frame data and input the generated frame data to the image processing model. At this time, a size of the generated frame data is enough for it to be processed in its stored state in a main memory of a computing device. That is, unlike the related art in which the frame data is stored in the secondary storage to be processed due to the large size of the frame data of the entire video, some frame data of the video has a relatively small size enough to be stored and processed in the main memory. To this end, it is obvious that those skilled in the art may appropriately set the size of the block data. In the meantime, the image processing model may be various image processing models, such as denoising or super resolution model.

Next, in a step S240, the processor may encode image data output from the image processing model according to the characteristic value (complexity) calculated in the step S210. For example, a bitrate is adjusted according to the characteristic value (complexity) by increasing a bitrate of a frame having a relatively high complexity and decreasing a bitrate of a frame having a relatively low complexity to perform the encoding. During this process, the processor may encode the image data within a bit resource which is allocated to the entire input video in advance. This part is different from the above-described block-based two-pass encoding. At this time, the size of the frame data output from the image processing model is also enough to be stored and processed in the main memory. Accordingly, the encoding process of the step S240 may also be executed while storing the frame data in the main memory of the computing device.

Next, in a step S250, the processor may determine whether the block data is extracted from the entire video. If the block data is not extracted from the entire video (“NO” in the step S250), the process may proceed to the step S220. The steps S220 to S250 may be repeated. In contrast, if the block data is extracted from the entire video (“YES” in the step S250), the encoding process is completed.

Next, the processor may integrate the encoded data to output as one video data. According to another exemplary embodiment, the processor may encode the image data output from the image processing model once to output as one video data. The encoding task may be paused and re-started so that image data output from the image processing model may be added to an encoding queue. In this case, clips in the block units may not be generated and one video may be output by one-time encoding. That is, the image processing and the encoding are simultaneously performed.

In the video encoding method according to another exemplary embodiment of the present disclosure, the characteristic of frames included in the entire video data is analyzed, and the frame is divided into block data to be encoded so that the video encoding method will be referred to as “separable two-pass encoding”. This is because the step (Pass 1) of calculating a characteristic value and the step (Pass 2) of encoding are spatially separated. According to the separable two-pass encoding according to the present disclosure, as compared with the related art, the data can be stored and processed in the main memory by adjusting the block size, without using the secondary storage device, so that a fast processing speed may be achieved. Further, unlike the block-based two-pass encoding, the bit resource is most appropriately distributed in the entire video to be encoded. Accordingly, if any one block of the entire video is simple, the extra bit resource may be distributed to another block. In contrast, after calculating the characteristic value (complexity) for the entire video data, the block division and encoding may be performed.

In the block-based two-pass encoding and the separable two-pass encoding according to the present disclosure, the video data is divided into block data to be processed so that it is advantageous in that the execution speed is fast while storing the block data in the main memory of the computing device. When the applicant executed the two-pass encoding of the related art (in which the entire frame was separated into a plurality of frames and then stored in HDD) on 37-second FHD video (816×1920) by excluding audio, with respect to two RTX 3090 GPUs, a total processing time including model inference and encoding was 22 minutes. In contrast, in the case of the block-based two-pass encoding and the separable two-pass encoding (in which only a part is sequentially stored in the memory) according to the present disclosure, a total processing time including model inference and encoding was 15 minutes, which resulted in the improvement of the processing speed of approximately 1.46 times as compared with the related art.

The video encoding method according to the present disclosure may include processors, application-specific integrated circuit (ASIC), other chipsets, logic circuits, registers, communication modems, and data processing devices which are known in the technical field to which the present disclosure belongs, to execute the above-described calculation and various control logics. Further, when the above-described control logic is implemented as software, the video encoding method may be implemented by a set of program modules. At this time, the program module may be stored in the memory device and be executed by the processor.

The above-described computer program may include a code which is coded by a computer language, such as C/C++, C#, JAVA, Python, or machine language which can be read by the processor (CPU) of the computer through a device interface of the computer to allow the computer to read the program and execute the method implemented by a program. Such a code may include a functional code related to a function which defines functions required to execute the above-described methods and include an execution procedure-related control code required for the processor of the computer to execute the functions according to a predetermined procedure. Such a code may further include a memory reference-related code indicating a location (address) of an internal or external memory of the computer where additional information or media required to allow the processor of the computer to execute the above-mentioned functions is referenced. Further, if the processor of the computer requires communication with any other remote computer or server to execute the functions, the code may further include a communication-related code about how to communicate with any other remote computer or server using a communication module of the computer and which information or media needs to be transmitted or received during the communication.

The storage medium refers to a medium that stores data semi-permanently and is readable by the device, rather than a medium that stores data for a short moment, such as registers, caches, and memories. Specifically, examples of the storage medium include a ROM, a RAM, a CD-ROM, a magnetic tape, a floppy disk, or an optical data storage device, but are not limited thereto. That is, the program may be stored in various recording media on various servers accessible by the computer or in various recording media on the computer of the user. Further, the media are distributed to computer systems connected through a network, so that a computer readable code may be stored and executed by a distribution method.

The exemplary embodiments of the present disclosure have been described with reference to the accompanying drawings, but those skilled in the art will understand that the present disclosure may be implemented in another specific form without changing the technical spirit or an essential feature thereof. Therefore, it should be understood that the above-described exemplary embodiments are illustrative in all aspects and do not limit the present disclosure.

1. A video encoding method, comprising:
(a) storing, by a processor, video data as input data;
(b) calculating, by a processor, a characteristic value for the entire video data;
(c) extracting, by a processor, block data with a predetermined size from the video data by the processor;
(d) inputting, by a processor, the block data to an image processing model; and
(e) encoding, by a processor, image data output from the image processing model based on the characteristic value calculated in the step (b),
wherein the steps (c) and (e) are repeated until the block data is extracted from the entire video data.

2. The video encoding method of claim 1, wherein the characteristic value is a complexity of an image.

3. The video encoding method of claim 2, wherein in the step (b), the processor calculates the complexity by at least any one of motion estimation, variability, a prediction error, quality constraints, macroblock partitioning, and cutaway.

4. The video encoding method of claim 1, wherein the step (d) is a step of generating the block data as at least one or more frame data and inputting the generated frame data to the image processing model by the processor.

5. The video encoding method of claim 1, wherein the image processing model is a denoising or super resolution model.

6. The video encoding method of claim 1, wherein the step (e) is a step of encoding the image data by adjusting a bitrate according to the characteristic value calculated in the step (b) by the processor.

7. The video encoding method of claim 1, wherein the step (e) is a step of encoding the image data in a bit resource which is allocated in advance to an entire input video, by the processor.

8. The video encoding method of claim 1, wherein the step (e) is a step of outputting the image data output from the image processing mode as one video data through one-time encoding.

9. The video encoding method of claim 1, further comprising:
(f) a step of integrating the encoded data by the processor to output as one video data.

10. The video encoding method of claim 1, wherein the steps (c) and (e) are executed while storing the image data in a main memory of a computing device.

11. A computer program which is created to perform each step of the video encoding method according to claim 1 in a computer to be recorded in a computer readable recording medium.
